(19) United States
(12) Patent Application Publication
(10) Pub. No.: US 2007/0172185 A1
(43) Pub. Date: Jul. 26, 2007

(54) Optical waveguide with mode shape for high efficiency modulation

(76) Inventor: John M. Hutchinson, Santa Barbara, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/338,949

(22) Filed: Jan. 25, 2006

(51) Int. Cl. G02B 6/10; G02B 6/00

(52) U.S. Cl. 385/129; 385/130; 385/141; 385/142

(57) ABSTRACT

A waveguide core is positioned proximate to a lower cladding layer, wherein the waveguide core includes a lower waveguide core layer and an upper waveguide core layer, the lower waveguide core layer having a lower refractive index than the upper waveguide core layer. An upper cladding layer is positioned proximate to the waveguide core.

### TECHNICAL FIELD

Embodiments of the invention relate to the field of optical waveguides and more specifically, but not exclusively, to an optical waveguide structure with improved mode shape for high efficiency modulation.

### BACKGROUND

Optical waveguides may be used in optical modulators, such as phase modulators, absorption modulators, and Mach-Zehnder Modulators (MZM). An optical modulator may be optically coupled to an external optical device, such as an optical fiber or photodetector. Today, the optical mode leaving the modulator is small in the vertical direction and produces a highly divergent beam. To collect the light exiting the optical modulator into free space, a lens or other device is used to couple the light leaving the optical modulator to an external optical device.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a diagram illustrating an optical waveguide in accordance with an embodiment of the invention.

FIG. 2A is a diagram illustrating the far-field intensity profile of a conventional optical waveguide.

FIG. 2B is a diagram illustrating the far-field intensity profile of an optical waveguide in accordance with an embodiment of the invention.

FIG. 3A is a diagram illustrating the mode profile of a conventional optical waveguide.

FIG. 3B is a diagram illustrating the mode profile of an optical waveguide in accordance with an embodiment of the invention.

FIG. 4 is a diagram illustrating a system having an optical waveguide in accordance with an embodiment of the invention.

### DETAILED DESCRIPTION

In the following description, numerous specific details are set forth to provide a thorough understanding of embodiments of the invention. One skilled in the relevant art will recognize, however, that embodiments of the invention can be practiced without one or more of the specific details, or with other methods, components, materials, etc. In other instances, well-known structures, materials, or operations are not shown or described in detail to avoid obscuring understanding of this description.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the following description and claims, the term “coupled” and its derivatives may be used. “Coupled” may mean that two or more elements are in direct contact (physically, electrically, magnetically, optically, etc.). “Coupled” may also mean two or more elements are not in direct contact with each other, but still cooperate or interact with each other.

Embodiments of the invention include an optical waveguide having an optical rib, ridge or buried waveguide structure. The optical waveguide includes an upper cladding, waveguide core and lower cladding, where the waveguide core includes at least two different semiconductor compositions. The upper core layer may have a wider bandgap (that is, higher refractive index) providing high electro-optic efficiency; the lower core layer being a narrow bandgap (that is, lower refractive index) to expand the optical mode. Embodiments of the waveguide structure described herein is suitable for modulators, but may also be applied to other semiconductor optoelectronic devices such as waveguide lasers, amplifiers, photodetectors and monolithically integrated versions of combinations of these devices.

Embodiments of the waveguide structure described herein improve the optical coupling efficiency from optical waveguides (e.g., Mach-Zehnder Modulator) to other devices and relaxing waveguide-to-lens or waveguide-to-waveguide alignment tolerances. Embodiments herein provide ease-of-manufacture and cost benefits over the current state of the art.

Currently, the optical mode produced by devices with a single waveguide core layer with high electro-optic efficiency is small in the vertical direction and produces a highly divergent beam. To collect the light exiting from the waveguide into free-space, expensive large numerical aperture lenses are used. The divergent beam also requires the coupling lens to be placed very close (several 10's to 100 microns) to the waveguide facet and the positioning alignment tolerance is tight.

Waveguide based “spot-size converters” have also been used in coupling optical modulators to external optical devices. There are several designs for spot-size converters, but they typically utilize a tapered waveguide thickness and/or ridge width. It is not convenient to manufacture vertically tapered waveguide layers, and processes such as selective epitaxial regrowth or some type of diffusion limited etch process are usually incorporated.

Embodiments of the invention enlarge the optical mode, significantly reducing the divergence of the waveguide device in the far-field, resulting in simpler and cheaper coupling optics (for example, smaller aperture lens at distances of a few 100's of microns from the facet) and relaxed alignment and positioning tolerances. The electro-optic efficiency is maintained. The base epitaxial layer structure (that is, the waveguide core layer) may have one additional layer be deposited, but no other changes to the manufacturing process are required.

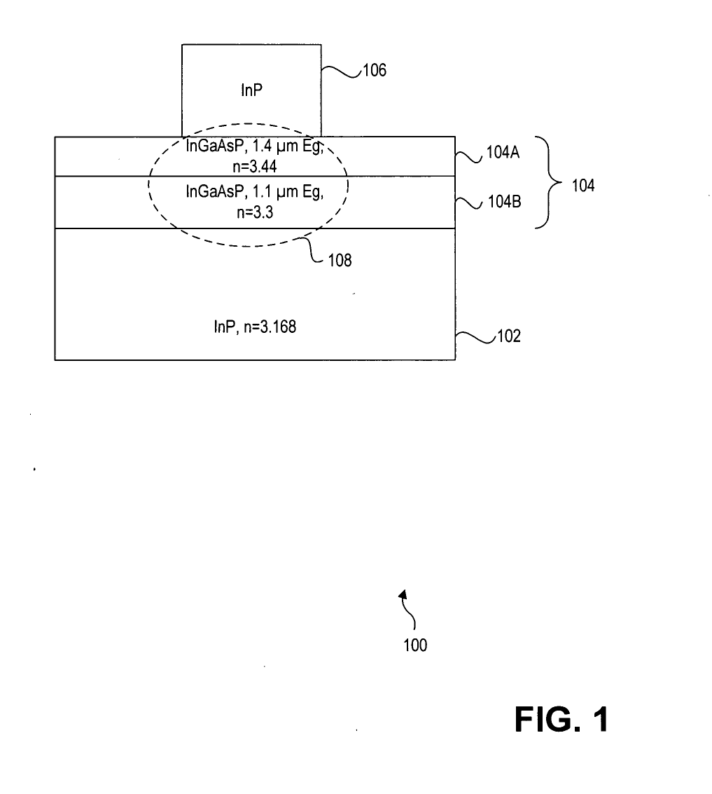

Turning to FIG. 1, a cross-section view of an optical waveguide 100 in accordance with an embodiment of the invention is shown. Optical waveguide 100 includes optical waveguide structures such as a rib waveguide, ridge waveguide, buried ridge waveguide, hetero-waveguide, or the like. In one embodiment, optical waveguide 100 includes a semiconductor optical waveguide. A semiconductor optical waveguide may include a lightly doped waveguide core and upper and lower claddings.

Optical waveguide 100 includes a lower cladding layer 102. Waveguide core 104 is positioned on lower cladding layer 102. An upper cladding layer 106 is positioned on waveguide core 104. In one embodiment, upper cladding layer 106 may be referred to as an upper cladding ridge or top cladding ridge of an optical ridge waveguide. The dashed oval 108 represents an approximate mode shape of an optical intensity within the semiconductor optical waveguide 100.

Waveguide core 104 includes an upper waveguide core layer 104A and a lower waveguide core layer 104B. The structure of waveguide core 104 may be referred to as a “double layer” waveguide.

In one embodiment, upper cladding layer 106 is approximately 3 micrometers (μm) wide by approximately 2 μm high. In this particular embodiment, waveguide core 104 has a total thickness of approximately 0.35 μm.

As will described further below, lower cladding layer 102, waveguide core 104, and upper cladding layer 106 may not necessary be in direct contact with each other, but one or more intervening layers may be present in optical waveguide 100. Further, it will be understood that the terms “upper” and “lower” or “top” and “bottom” are used herein for ease of description but do not limit embodiments of the invention to any particular orientation in free space or configuration.

Embodiments of the invention include a ridge semiconductor optical waveguide diode structure made with a device design and epitaxial structure that provide high efficiency phase modulation and enlarges the optical mode shape to ease coupling to external optical devices by separating the waveguide core into at least two different active waveguide layers. In one embodiment, upper waveguide core layer 104A may include a wider bandgap material (that is, higher refractive index) to provide high electrontic efficiency in modulators; lower waveguide core layer 104B may include a narrow bandgap (that is, lower refractive index) material than the upper waveguide core layer 104A to expand the optical mode.

In the embodiment of FIG. 1, upper cladding layer 106 includes a P-type InP (Indium Phosphide) semiconductor and lower cladding layer 102 includes an N-type InP semiconductor. Upper waveguide core layer 104A includes a quaternary composition of Indium Gallium Arsenide Phosphide (InGaAsP) having a 1.4 micrometer (μm) bandgap (Eg) and a refractive index (n) of 3.44 at an optical wavelength 1550 nanometers (nm). Lower waveguide core layer 104B includes a different quarternary material composition of InGaAsP having a 1.1 micrometer (μm) bandgap (Eg) and refractive index (n) of 3.3 at an optical wavelength 1550 nm.

Bandgap (Eg) is described herein in micrometers (μm). It will be understood that bandgap may be alternatively expressed in electronvolts (eV). The conversion between micrometers and eV is Eg(eV)=1.24/(Eg(μm)). In other words, bandgap E=hν, where h is Planck's constant and ν is the frequency. To convert to wavelengths, ν=c/λ, where c is the speed of light. So the conversion factor from eV to micrometers is E=(hc/q)*(1/Eg(μm)), where h is Planck's constant, c is the speed of light, and q is the electron charge.

In the embodiment of FIG. 1, upper waveguide core layer 104A may have a bandgap of 1.4 μm (or 0.88 eV). Lower waveguide core layer 104B may have a bandgap of 1.1 μm (or 1.12 eV).

In one embodiment, upper waveguide core layer 104A has a thickness of approximately 100 nm and lower waveguide core layer 104B has a thickness of approximately 250 nm. The bandgap of the quarternary waveguide is placed close to the 1550 nm operating wavelength to provide high electro-optic phase or absorption efficiency while minimizing excess optical absorption.

In a phase modulator (such as a Mach-Zehnder Modulator) or absorption modulator, a waveguide diode is reverse biased and a depletion region and hence an electric field is set up near the pn junction. The pn junction is formed at the interface of the top of the waveguide and InP upper cladding. High electric fields are necessary to effect sufficient refractive index change in the device for modulation (referred to as the electro-optic effect).

To provide high electric fields, the waveguide is typically doped approximately 1-2×10¹⁷ cm⁻³, which limits the depletion region to approximately 100 nm of the approximately 350 nm thick waveguide layer. Hence, the remaining 250 nm of the waveguide core does not contribute to the electro-optic index change. Embodiments herein replace this remaining portion with a lower refractive index material (waveguide core layer 104B). In one embodiment, the lower waveguide core layer 104B may require one additional layer to be deposited, but no other changes are needed in the manufacturing process.

In one embodiment, the refractive index difference between upper waveguide core layer 104A and lower waveguide core layer 104B (n_{WG1}-n_{WG2}) may be approximately 0.015. In another embodiment, the refractive index difference between the lower waveguide core layer 104B and lower cladding 102 (n_{WG2}-n_{Clad}) may be approximately 0.015. Too large of a refractive index difference results in higher mode confinement, a smaller mode diameter and larger angular divergence when the beam diffracts into free space.

Embodiments of upper cladding 106 and lower cladding 102 may include Indium Phosphide, Gallium Arsenide, Gallium Nitride, Silicon, Germanium, mixtures of these materials, or the like. Embodiments of waveguide core 104 may include InGaAsP, Indium Gallium Aluminum Arsenide (InGaAlAs), Aluminum Gallium Arsenide (AlGaAs), Aluminum Gallium Nitride (AlGaN), Silicion, Germanium, or the like.

In an alternative embodiment, waveguide core 104 may include additional waveguide layers. Each additional waveguide layer may have a progressively lower refractive index as the layers are closer to lower cladding 102.

In another embodiment, waveguide core 104 may include a graded index layer. The graded index layer includes adjusting the material composition, and hence, refractive index such that the index decreases continuously from the top of waveguide core 104. Such designs minimize interfacial effects which may be present in the double layer waveguide which may have a step discontinuity between waveguide core layers 104A and 104B.

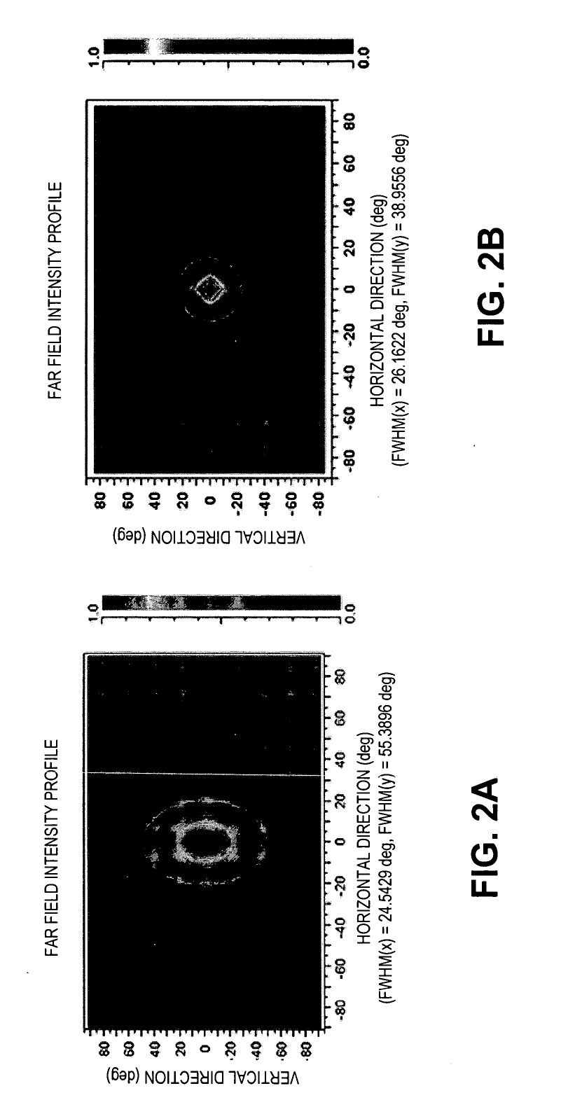

Turning to FIGS. 2A and 2B, the effect of the double layer waveguide core structure on far-field or angular divergence out of the waveguide facet is shown. Highly divergent beams, or those with large angles, use coupling lenses having large apertures and are located close to the facet. FIG. 2A shows far-field divergence of a conventional waveguide; FIG. 2B shows far-field divergence of optical waveguide 100. The conventional waveguide has a 350 nm thick waveguide core with a single layer of InGaAsP, 1.4 micrometer (μm) Eg, and refractive index (n) of 3.45 at 1550 nm wavelength. The lower cladding of the conventional waveguide includes InP with n-3.168. Far-field shows the divergence at 10-100s of microns outside of the waveguide in free space, as opposed to near-field which may be a few microns from the waveguide.

FIG. 2B shows lower angular divergence of the optical mode exiting the waveguide in the far-field than in FIG. 2A. The reduced divergence results in easier optical coupling with an external optical device as there is no need for a lens or other device for the coupling. The reduced divergence also provides for relaxed alignment tolerances in the coupling to an external device. Alignment tolerances are relaxed because less divergence results in the optical energy being maintained within a smaller diameter.

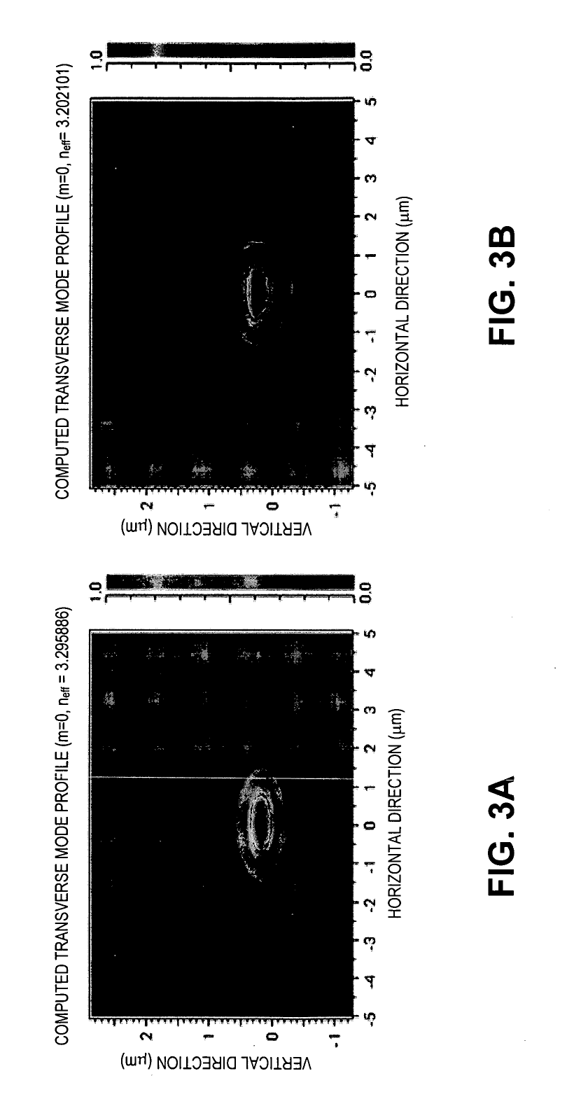

Turning to FIGS. 3A and 3B, the effect of the double layer waveguide core on the mode shape is shown. FIG. 3A shows mode shape of the conventional waveguide described above; FIG. 3B shows mode shape of optical waveguide 100. In FIG. 3B, the waveguide mode shape of the double-layer structure is seen to expand in the vertical direction due to the lower index mismatch of the lower waveguide core layer 104B (n=3.3) and lower cladding 102 (n=3.168). The expanded mode shape directly results in reduced far-field divergence (shown in FIG. 2B). In the embodiment of FIG. 3B, the vertical divergence of the double layer structure is 39° FWHM (Full-Width Half-Maximum) compared to 50° FWHM for the conventional single layer waveguide structure in FIG. 3A. Beam propagation methods (BPM) were used to simulate FIGS. 2A, 2B, 3A, and 3B.

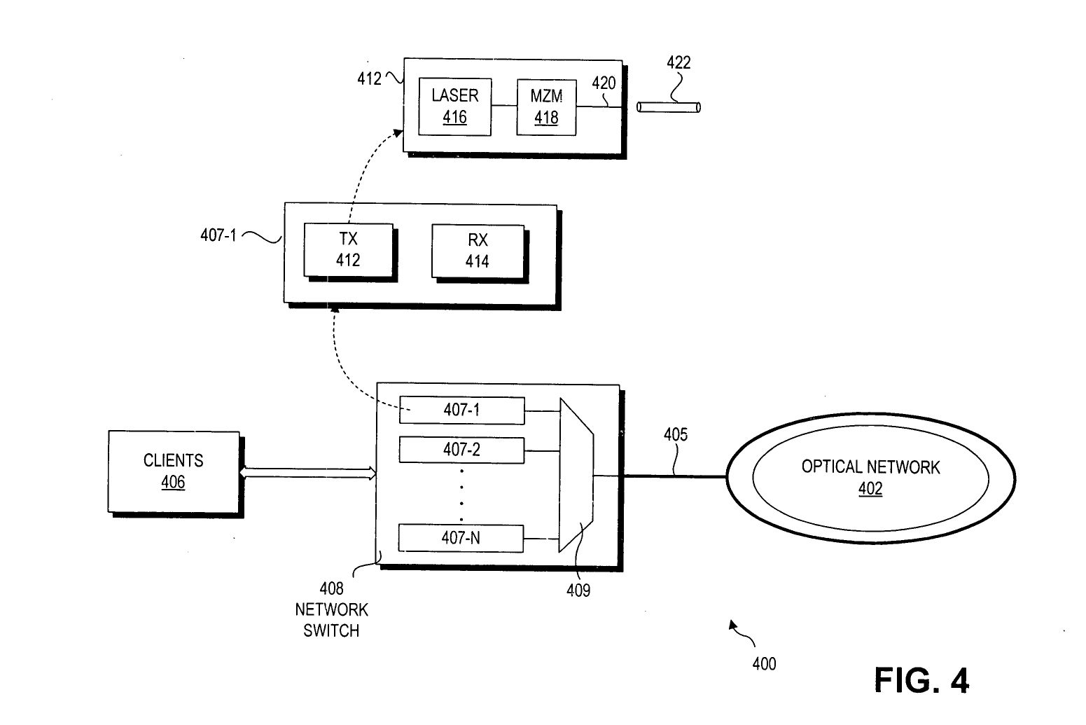

Turning to FIG. 4, an embodiment of a system 400 including a modulator with an optical waveguide as described herein is shown. System 400 includes a network switch 408 coupled to an optical network 402 via optical link 405. In one embodiment, optical link 405 includes one or more optical fibers. Network switch 408 is also coupled to one or more clients 406. Embodiments of client 406 include a router, a server, a host computer, a phone system, or the like.

Network switch 408 includes transponders 407-1 to 407-N coupled to a multiplexer/demultiplexer 409. A transponder 407 converts between optical signals of optical network 402 and electrical signals used by clients 406. Multiplexer/demultiplexer 409 is a passive optical device that divides wavelengths (or channels) from a multi-channel optical signal, or combines various wavelengths (or channels) on respective optical paths into one multi-channel optical signal depending on the propagation direction of the light. In one embodiment, system 400 employs Wavelength Division Multiplexing (WDM), Dense Wavelength Division Multiplexing (DWDM), Frequency Division Multiple Access (FDMA), or the like.

Each transponder 407 may include an optical transmitter 412 and optical receiver 414. In one embodiment, optical transmitter 412 includes a waveguide structure as described herein. In one embodiment, optical transmitter 412 includes a laser 416 optically coupled to MZM 418. MZM 418 includes waveguide 420 for optically coupling MZM 418 to an external optical device, such as optical fiber 422. Waveguide 420 includes a multi-layer waveguide core as described herein. Other external optical devices include lenses, optical isolators as well as other semiconductor optical devices such as lasers and photodetectors.

Various operations of embodiments of the present invention are described herein. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment of the invention.

The above description of illustrated embodiments of the invention, including what is described in the Abstract, is not intended to be exhaustive or to limit the embodiments to the precise forms disclosed. While specific embodiments of, and examples for, the invention are described herein for illustrative purposes, various equivalent modifications are possible, as those skilled in the relevant art will recognize. These modifications can be made to embodiments of the invention in light of the above detailed description. The terms used in the following claims should not be construed to limit the invention to the specific embodiments disclosed in the specification. Rather, the following claims are to be construed in accordance with established doctrines of claim interpretation.

What is claimed is:

1. An apparatus, comprising:
a lower cladding layer;
a waveguide core positioned proximate to the lower cladding layer, wherein the waveguide core includes a lower waveguide core layer and an upper waveguide core layer, the lower waveguide core layer having a lower refractive index than the upper waveguide core layer; and
an upper cladding layer positioned proximate to the waveguide core.

2. The apparatus of claim 1 wherein the waveguide core includes a semiconductor waveguide material.

3. The apparatus of claim 2 wherein the lower waveguide core layer includes Indium Gallium Arsenide Phosphide (InGaAsP).

4. The apparatus of claim 2 wherein the upper waveguide core layer includes Indium Gallium Arsenide Phosphide (InGaAsP).

5. The apparatus of claim 1 wherein in the upper cladding layer and the lower cladding layer each include a semiconductor material.

6. The apparatus of claim 5 wherein the semiconductor material includes Indium Phosphide (InP).

7. The apparatus of claim 1 wherein a difference between a refractive index of the upper waveguide core layer and a refractive index of the lower waveguide core layer is approximately 0.015.

8. The apparatus of claim 1 wherein a difference between a refractive index of the lower waveguide core layer and a refractive index of the lower cladding layer is approximately 0.015.

9. An apparatus, comprising:
a lower cladding layer;
a waveguide core positioned proximate to the lower cladding layer, wherein the waveguide core includes means for enlarging an optical mode shape of an optical signal passing through the waveguide core and for reducing divergence of the optical mode shape exiting the waveguide core; and
an upper cladding layer positioned proximate to the waveguide core.

10. The apparatus of claim 9 wherein the means for enlarging the optical mode shape of the optical signal passing through the waveguide core and for reducing divergence of the optical mode shape exiting the waveguide core includes a lower waveguide core layer and an upper waveguide core layer, the lower waveguide core layer having a lower refractive index than the upper waveguide core layer.

11. The apparatus of claim 10 wherein the upper waveguide core layer includes Indium Gallium Arsenide Phosphide (InGaAsP).

12. The apparatus of claim 10 wherein the lower waveguide core layer includes Indium Gallium Arsenide Phosphide (InGaAsP).

13. The apparatus of claim 10 wherein a difference between a refractive index of the upper waveguide core layer and a refractive index of the lower waveguide core layer is approximately 0.015.

14. The apparatus of claim 10 wherein a difference between a refractive index of the lower waveguide core layer and a refractive index of the lower cladding layer is approximately 0.015.

15. The apparatus of claim 10 wherein the upper waveguide core layer has a thickness of approximately 100 nanometers, wherein the lower waveguide core layer has a thickness of approximately 250 nanometers.

16. The apparatus of claim 9 wherein the apparatus includes a semiconductor optoelectronic device.

17. A system, comprising:
an optical fiber; and
a semiconductor optoelectronic device optically coupled to the optical fiber, wherein the semiconductor optoelectronic device includes:
a lower cladding layer;
a waveguide core positioned proximate to the lower cladding layer, wherein the waveguide core includes a lower waveguide core layer and an upper waveguide core layer, the lower waveguide core layer having a lower refractive index than the upper waveguide core layer; and
an upper cladding layer positioned proximate to the waveguide core.

18. The system of claim 17 wherein the upper waveguide core layer includes Indium Gallium Arsenide Phosphide (InGaAsP), wherein the lower waveguide core layer includes Indium Gallium Arsenide Phosphide (InGaAsP).

19. The system of claim 17 wherein a difference between a refractive index of the upper waveguide core layer and a refractive index of the lower waveguide core layer is approximately 0.015.

20. The system of claim 17 wherein a difference between a refractive index of the lower waveguide core layer and a refractive index of the lower cladding layer is approximately 0.015.
